(19) United States
(12) Patent Application Publication
(10) Pub. No.: US 2021/0067584 A1
(43) Pub. Date: Mar. 4, 2021

(54) SYSTEM AND METHOD FOR SERVICE CLOUD OFFLOADING TO MULTIFUNCTION PERIPHERALS

(71) Applicant: Toshiba TEC Kabushiki Kaisha, Shinagawa-ku (JP)

(72) Inventors: Kevin NGUYEN, Lake Forest, CA (US); Milong SABANDITH, Irvine, CA (US)

(21) Appl. No.: 16/554,864

(22) Filed: Aug. 29, 2019

(51) Int. Cl. H04L 29/08; G06F 9/50; G06F 1/3234; G06F 9/48

(52) U.S. Cl. CPC H04L 67/1012; H04L 67/1027; G06F 9/4856; G06F 9/505; G06F 1/3234; G06F 9/5072

(57) ABSTRACT

A system and method for offloading service cloud tasks to multifunction peripherals includes a service cloud that transmits an application to a multifunction peripheral. The multifunction peripheral receives the application into memory and executes the application. The application performs a management task associated with the multifunction peripheral similarly to how the service cloud would perform the management task. Once the management task has been performed, the application transmits synchronization data with the service cloud. Offloading the management task to the multifunctional peripheral substantially reduces the computational load on the service cloud.

### TECHNICAL FIELD

This application relates generally to offloading service cloud tasks to multifunction peripherals. The application relates more particularly to deploying applications on multifunction peripherals to perform tasks typically performed by the service cloud.

### BACKGROUND

Document processing devices include printers, copiers, scanners and e-mail gateways. More recently, devices employing two or more of these functions are found in office environments. These devices are referred to as multifunction peripherals (MFPs) or multifunction devices (MFDs). As used herein, MFPs are understood to comprise printers, alone or in combination with other of the afore-noted functions. It is further understood that any suitable document processing device can be used.

Multiple MFPs can be managed by a service cloud. Management of MFPs by a service cloud benefits administrators and technicians who can administer and monitor operations of MFPs without needing to go physically onsite to manage each device. However, as more devices are managed by the service cloud the increased load can decrease the performance of the service cloud and increase the cost of maintaining the service cloud.

### BRIEF DESCRIPTION OF THE DRAWINGS

Various embodiments will become better understood with regard to the following description, appended claims and accompanying drawings wherein:

FIG. 1 is an example embodiment of a system for offloading service cloud applications to MFPs;

FIG. 2 is an example embodiment of a multifunction peripheral;

FIG. 3 is an example embodiment of a computing platform; and

FIG. 4 is a flowchart of example operations of a system for offloading service cloud applications to MFPs.

### DETAILED DESCRIPTION

The systems and methods disclosed herein are described in detail by way of examples and with reference to the figures. It will be appreciated that modifications to disclosed and described examples, arrangements, configurations, components, elements, apparatuses, devices, methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

MPFs have the capability of receiving and executing new applications. Applications can be used to add new features to increase the functionality of MFPs. Typically, applications are downloaded to MFPs from a service cloud. The service cloud sends custom application packages to MFPs that can include one or several applications and customizations for each of the MFPs.

In accordance with the subject application, the service cloud can transmit an application to an MFP that enables the MFP to perform one or more service cloud tasks associated with management of the MFP. The application performs each management task similarly to how the task would be performed by the service cloud itself. In this way, the service cloud can offload tasks to MFPs, thereby reducing the load on the service cloud. Currently, the service cloud handles the management tasks for MFPs. The subject invention reduces the processing requirements for executing these tasks by offloading tasks to individual MFPs to perform. By offloading computationally intensive tasks to MFPs, the load on the service cloud can be substantially reduced improving the performance of the service cloud and decreasing the cost of operating and maintaining the service cloud.

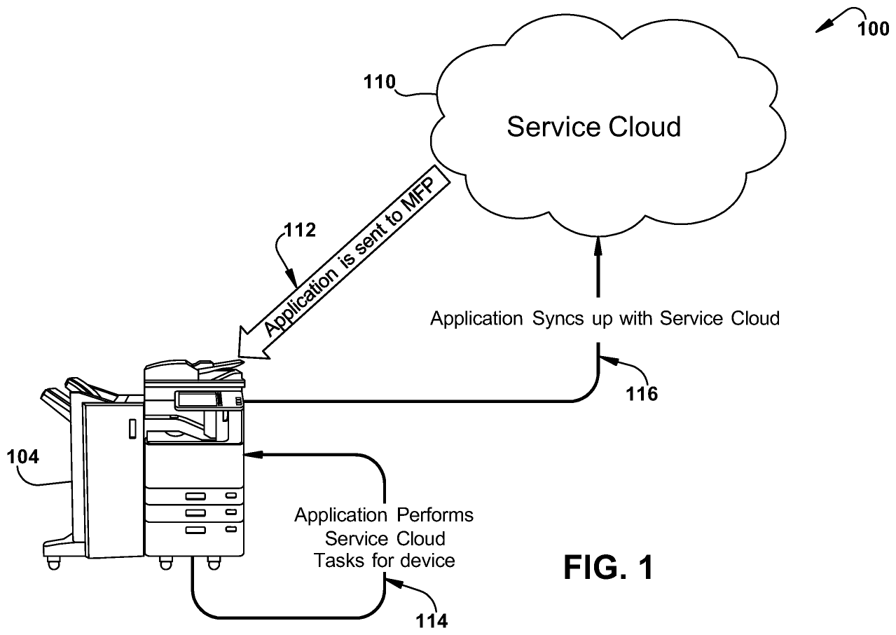

In accordance with the subject application, FIG. 1 illustrates an example embodiment of a system 100 for offloading service cloud applications to MFPs that includes one or more MFPs, illustrated by way of example by MFP 104. MFP 104 is in network communication with service cloud 110, suitably comprised of cloud computing capability accessible via any wireless or wired local area network (LAN) or a wide area network (WAN) which can comprise the Internet, or any suitable combination thereof. The subject example embodiment reflects interaction with a service cloud 110, however it will be appreciated that any suitable distributed computing platform or computing device may be used, including a workstation, server, or other discrete computing device.

To offload a management task to the MFP 104, the service cloud 110 first downloads an application 112 to the MFP 104. The MFP 104 then executes the application 112 which performs a task 114 that is normally performed by the service cloud 110. The application 112 then sends one or more synchronization messages 116 as necessary to synchronize the application 112 with the service cloud 110. The particular synchronization messages 116 communicated between the application 112 and the service cloud 110 depend on the particular task 114 that is performed.

To reduce processing load on the service cloud 110, the service cloud 110 can offload a task 114 to the MFP 104 that requires significant processing power to perform. For example, the service cloud 110 can offload the task 114 of generating email each time an MFP 104 reports an error to the service cloud 110. The application 112 can handle this task 114 by generating the email and transmitting the email to a designated recipient. The application 112 would then send a synchronization message 116 to the service cloud 110, for example a copy of the email that was generated and sent, or a signal that email was sent.

In various embodiments, the application 112 can be configured to execute a specific management task 114, for example the task 114 of generating email when errors occur, or the application 112 can be configured to receive one or more different tasks from the service cloud 110. For example, in various embodiments the service cloud 110 offloads one or more computationally demanding tasks 114 to the MFP 104 which reduces demand on the service cloud 110. In other embodiments the service cloud 110 can selectively distribute tasks 114 to an MFP 104 during peak performance times in order to shed load as needed. In yet other embodiments, the task 114 that is offloaded can help to reduce network congestion on the service cloud 110. For example, generating and sending email from each MFP 104 instead of the service cloud 110 helps to distribute network traffic due to the email throughout the network and reduces the volume of email being sent by the service cloud 110 itself, thereby reducing network congestion at the service cloud 110.

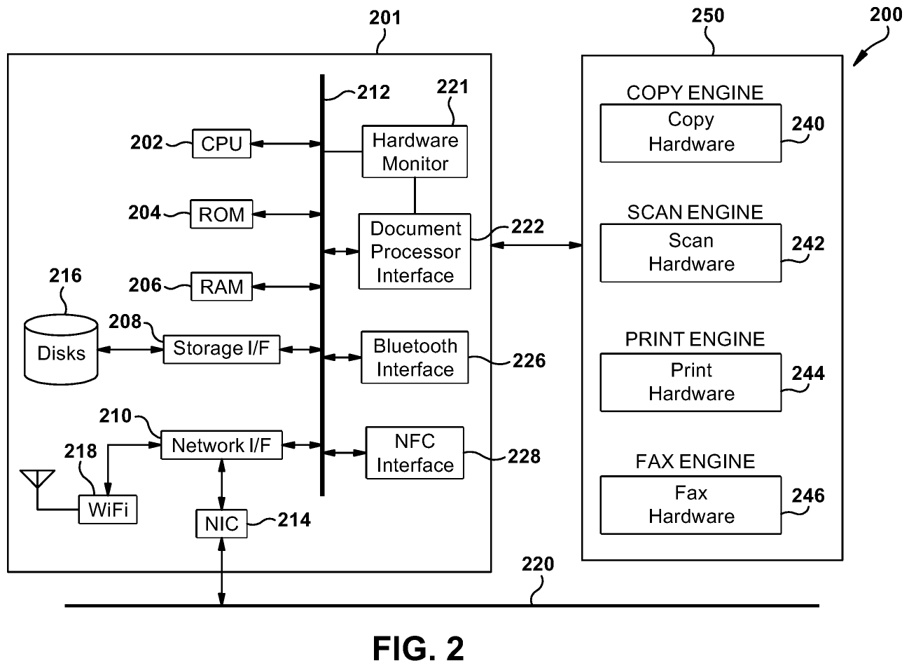

Turning now to FIG. 2 illustrated is an example embodiment of a networked digital device comprised of document rendering system 200 suitably comprised within an MFP, such as with MFP 104 of FIG. 1. It will be appreciated that an MFP includes an intelligent controller 201 which is itself a computer system. Included in controller 201 are one or more processors, such as that illustrated by processor 202. Each processor is suitably associated with non-volatile memory, such as read only memory (ROM) 204, and random access memory (RAM) 206, via a data bus 212.

Processor 202 is also in data communication with a storage interface 208 for reading or writing data with storage 216, suitably comprised of a hard disk, optical disk, solid-state disk, cloud-based storage, or any other suitable data storage as will be appreciated by one of ordinary skill in the art.

Processor 202 is also in data communication with a network interface 210 which provides an interface to a network interface controller (NIC) 214, which in turn provides a data path to any suitable wired or physical network connection 220, or to a wireless data connection via a wireless network interface, such as WiFi 218. Example wireless connections include cellular, Wi-Fi, wireless universal serial bus (wireless USB), satellite, and the like. Example wired interfaces include Ethernet, USB, IEEE 1394 (FireWire), Lightning, telephone line, or the like. Processor 202 is also in data communication with a hardware monitor 221, suitably amassing state data from subassemblies, sensors, digital thermometers, or the like, and suitably including digital state date including device codes, such as device error codes.

Processor 202 can also be in data communication a document processor interface 222, with Bluetooth interface 226 and NFC interface 228 via data path 212. Processor 202 can be in data communication with any suitable user input/output (I/O) interface (not shown) which provides data communication with user peripherals, such as displays, keyboards, mice, track balls, touch screens, or the like.

Document processor interface 222 is suitable for data communication with MFP functional units 250. In the illustrate example, these units include a copy engine, suitably comprised of copy hardware 240, a scan engine, suitably comprised of scan hardware 242, a print engine, suitably comprised of print hardware 244 and a fax engine, suitably comprised of fax hardware 246. These subsystems together comprise MFP functional hardware 250. It will be understood that functional units are suitably comprised of intelligent units, including any suitable hardware or software platform.

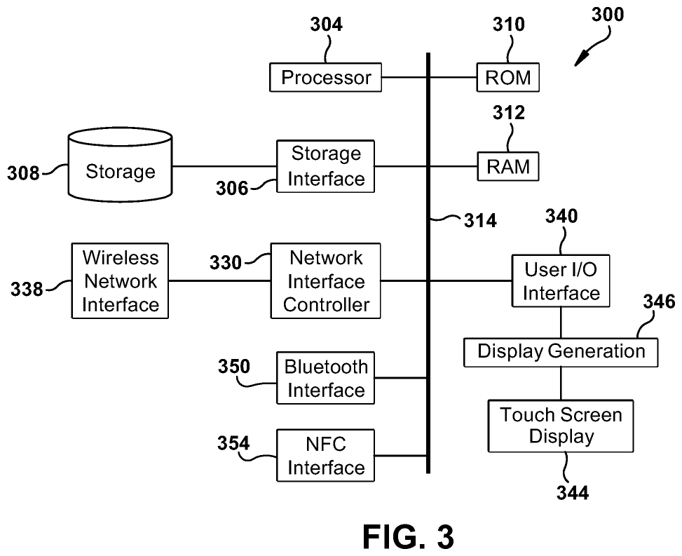

Turning now to FIG. 3, illustrated is an example of a computing platform such as the service cloud of FIG. 1. Included are one or more processors, such as that illustrated by processor 304. Each processor is suitably associated with non-volatile memory, such as read only memory (ROM) 310 and random access memory (RAM) 312, via a data bus 314.

Processor 304 is also in data communication with a storage interface 306 for reading or writing to a data storage system 308, suitably comprised of a hard disk, optical disk, solid-state disk, or any other suitable data storage as will be appreciated by one of ordinary skill in the art.

Processor 304 is also in data communication with a network interface controller (NIC) 330, which provides a data path to any suitable network or device connection, such as a suitable wireless data connection via wireless network interface 338. A suitable data connection to an MFP or server is via a data network, such as a local area network (LAN), a wide area network (WAN), which may comprise the Internet, or any suitable combination thereof. A digital data connection is also suitably directly with an MFP or server, such as via Bluetooth, optical data transfer, Wi-Fi direct, or the like.

Processor 304 is also in data communication with a user input/output (I/O) interface 340 which provides data communication with user peripherals, such as touch screen display 344 via display generator 346, as well as keyboards, mice, track balls, touch screens, or the like. Processor 304 is also in data communication with Bluetooth interface 350 and NFC interface 354. It will be understood that functional units are suitably comprised of intelligent units, including any suitable hardware or software platform.

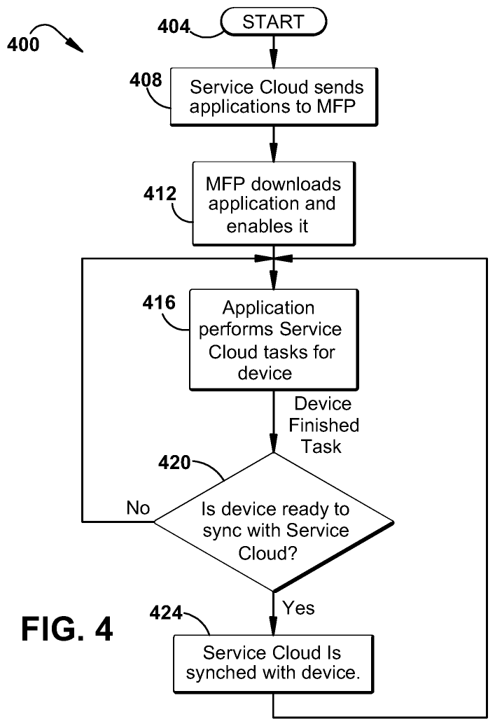

FIG. 4 is a flowchart 400 of example operations of a system for offloading service cloud tasks to MFPs. Operation starts at block 404 and proceeds to block 408. At block 408, the service cloud sends an application to one or more MFPs. For example, the application can be transmitted to MFPs individually or as part of a service pack which can include multiple applications and configurations. At block 412, the MFP receives the application and executes the application enabling it to begin performing one or more tasks for the service cloud. At block 416, the application executing on the MFP performs one or more tasks for the service cloud, for example a management task for the MFP that is ordinarily performed by the service cloud.

After each task is performed, progress is made to block 420. At block 420 a check is made to determine whether to synchronize with the service cloud. If so, then at block 424 the application executing on the MFP sends synchronization data to the service cloud and progress returns to block 416 to continue executing tasks. If not, then progress returns to block 416 to continue executing tasks on the MFP for the service cloud. Synchronization can be coordinated between the MFP and the service cloud based on multiple factors such as what task has been performed, the type of synchronization data, the amount of synchronization data, and the performance level of the service cloud. For example, if the service cloud is under a heavy load, synchronization can be delayed until a period of time when the service cloud is under a lighter load. Similarly, if the task is performed on the MFP to reduce possible network congestion, then synchronization can be performed at a time when network traffic is lower or in a manner designed to minimize the impact to the service cloud.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the spirit and scope of the inventions.

What is claimed is:

1. A multifunction peripheral, comprising:
a network interface configured to receive, from a service cloud, an application for performing a management task relating to the multifunction peripheral for the service cloud;
a memory configured to store the application; and
a processor configured to execute the application to perform the management task on the multifunction peripheral.

2. The multifunction peripheral of claim 1, wherein the processor is further configured to generate, for the service cloud, synchronization data associated with completion of the management task.

3. The multifunction peripheral of claim 2, wherein the network interface is further configured to selectively transmit the synchronization data between the multifunction peripheral and the service cloud.

4. The multifunction peripheral of claim 3, wherein the synchronization data is selectively transmitted to the service cloud to minimize an impact on the service cloud.

5. The multifunction peripheral of claim 4, wherein the impact is selected from the group consisting of a substantial increase in network traffic and a substantial increase in computational load on the service cloud.

6. The multifunction peripheral of claim 1, wherein the management task requires a substantial amount of computational power to execute.

7. The multifunction peripheral of claim 6, wherein offloading the management task to the multifunctional peripheral substantially reduces the computational load on the service cloud.

8. The multifunction peripheral of claim 1, wherein offloading the management task to the multifunctional peripheral substantially reduces network congestion at the service cloud.

9. A method, comprising:
receiving from a service cloud, by a network interface of a multifunction peripheral, an application for performing a management task relating to the multifunction peripheral for the service cloud;
storing, in a memory, the application for performing the management task; and
executing, by a processor of the multifunction peripheral, the application to perform the management task for the service cloud on the multifunction peripheral.

10. The system of claim 9, further comprising:
generating, by the processor, synchronization data associated with completion of the management task for the service cloud.

11. The method of claim 9, further comprising:
selectively transmitting, by the network interface, the synchronization data between the multifunction peripheral and the service cloud.

12. The method of claim 11, wherein the synchronization data is selectively transmitted to the service cloud to minimize an impact on the service cloud.

13. The method of claim 12, wherein the impact is selected from the group consisting of a substantial increase in network traffic and a substantial increase in computational load on the service cloud.

14. The method of claim 9, wherein the management task requires a substantial amount of computational power to execute, and wherein offloading the management task to the multifunctional peripheral substantially reduces the computational load on the service cloud.

15. The method of claim 9, wherein offloading the management task to the multifunctional peripheral substantially reduces network congestion at the service cloud.

16. A system comprising:
one or more processors configured to execute a plurality of management tasks relating to a plurality of multifunctional peripherals; and
a network interface configured to transmit an application to at least one multifunction peripheral to offload at least one of the management tasks to the at least one multifunction peripheral.

17. The system of claim 16, further comprising:
a service cloud comprising the processors and network interface; and
the plurality of multifunction peripherals.

18. The system of claim 16, wherein the network interface is further configured to receive synchronization data from a multifunction peripheral subsequent to completion of a management task by the multifunction peripheral.

19. The system of claim 16, wherein offloading the management task to the multifunctional peripheral substantially reduces the computational load on the service cloud.

20. The system of claim 19, wherein one or more of the processors is further configured to determine which management task to offload to the at least one multifunction peripheral.
